(19) United States
(12) Patent Application Publication
(10) Pub. No.: US 2025/0173443 A1
(43) Pub. Date: May 29, 2025

(54) PATCH-BASED VULNERABILITY DISCOVERY USING MACHINE LEARNING

(71) Applicant: SAP SE, Walldorf (DE)

(72) Inventors: Tom GANZ, Karlsruhe (DE); Martin HAERTERICH, Walldorf (DE); Erik IMGRUND, Heidelberg (DE)

(21) Appl. No.: 18/522,697

(22) Filed: Nov. 29, 2023

(51) Int. Cl. G06F 21/57; G06F 8/41; G06F 8/65; G06F 11/36

(52) U.S. Cl. CPC G06F 21/577; G06F 8/433; G06F 8/65; G06F 11/3604

(57) ABSTRACT

A system and method include reception of code files of a program, the program including code regions changed by applying a patch to the program, generation of an interprocedural data flow graph from the code files, identification of first nodes of the graph representing the code regions changed by applying the patch to the program, identification of a plurality of paths of the graph, each of the identified paths originating at a source node of the graph, including at least one of the identified first nodes, and terminating at a sink node of the graph, where each of the identified first nodes is included in at least one of the identified plurality of paths, combination of the identified plurality of paths based on their common first nodes to generate a reduced graph, and input of the reduced graph to a trained classification model to generate a classification.

### BACKGROUND

A software program consists of instructions, often organized into modules or procedures, which describe a sequence of desired corresponding computer operations. Most software programs are written in high-level programming languages which are translated into processor-executable machine language using a compiler, an interpreter, or a combination of the two. A software program may consist of one or more files which, for example, may be independently compiled and then linked together into a single executable file.

Changes to programs are often desired to provide feature updates and/or bug fixes. Programs are typically changed via software patches which specify differences, at the code statement level, between an existing program and a “patched” version of the program. The increased adoption of continuous integration (CI) and continuous deployment (CD) has exacerbated the need to monitor proposed patches for potential bugs and security risks, which will be referred to herein collectively as vulnerabilities. In particular, and to maintain a secure and reliable software development lifecycle, organizations desire robust software quality assurance processes for identifying and mitigating vulnerabilities before patches are applied within production systems.

The traditional approach to identifying software vulnerabilities relies on manual code reviews and extensive testing. This approach is time-consuming, resource-intensive, and prone to human error. Static program analysis tools, on the other hand, allow developers and security professionals to identify potentially-flawed patch code without actually running the patched program. Unfortunately, such tools often report false positive alerts, the resolution of which requires expensive manual triage.

Methods for learning-based vulnerability detection have been proposed to automatically derive rules from historical data. However, the prevailing machine learning (ML) models focus exclusively on features in local code regions, such as functions, statements or code slices. Consequently, these models are unsuitable for patch-based software development, in which version-to-version changes can span multiple files and functions. Moreover, these ML models are not context or flow-sensitive, and thus suffer from low generalizability and transferability in realistic settings.

Due to the foregoing, it would be beneficial to efficiently identify vulnerabilities at the patch level. A naive approach would consist of gluing together all snippets changed by a patch, and then evaluating the vulnerability of the patch using a decision function that operates on the function or statement level. In addition to the high false-positive rate mentioned above, such an approach would fail to identify many vulnerabilities which are potentially introduced by the patch.

For example, a vulnerability often spans multiple code modules, so even though the changes of a patch may only apply to certain code functions and modules, the changes should be analyzed with respect to the surrounding code. Moreover, a patch might not correspond to a single feature change but may potentially affect other non-patched modules. A patch may introduce a vulnerability in a program which does not manifest until several additional patches have been subsequently applied to the program. In addition, since the feature representation of a program may change as the program evolves over time, the performance of a learning-based analyzer trained on an earlier version of the program will likely degrade over time.

### BRIEF DESCRIPTION OF THE DRAWINGS

FIG. 1 illustrates a system to determine vulnerability of a software patch according to some embodiments.

FIGS. 2A and 2B comprise a flow diagram of a process to determine vulnerability of a software patch according to some embodiments.

FIG. 3 illustrates an interprocedural data flow graph according to some embodiments.

FIG. 4 illustrates source, sink and edit nodes of an interprocedural data flow graph according to some embodiments.

FIG. 5 illustrates a forward edit path from an edit node to a sink node of an interprocedural data flow graph according to some embodiments.

FIG. 6 illustrates a backward edit path from an edit node to a source node of an interprocedural data flow graph according to some embodiments.

FIG. 7 illustrates a plurality of edit paths of an interprocedural data flow graph according to some embodiments.

FIG. 8 illustrates a reduced graph of a plurality of edit paths according to some embodiments.

FIG. 9 is a flow diagram of a process to train a classification model to output a label based on a reduced graph of a plurality of edit paths according to some embodiments.

FIG. 10 is a diagram of a system to generate labeled reduce graphs according to some embodiments.

FIG. 11 illustrates training of a model using labeled reduced graphs according to some embodiments.

FIG. 12 is a user interface to present a classification of a software patch according to some embodiments.

FIG. 13 is a diagram of a cloud-based implementation according to some embodiments.

### DETAILED DESCRIPTION

The following description is provided to enable any person in the art to make and use the described embodiments. Various modifications, however, will be readily-apparent to those in the art.

Some embodiments facilitate effective identification of vulnerabilities in patches. Tools implementing some embodiments may therefore be advantageously suited for incorporation into a CI/CD software development process.

To address the issues described above, some embodiments utilize a new graph representation which considers the context of a patch and may include a value-set analysis. This graph representation allows security practitioners to analyze interprocedural data and control flow from potentially attacker-controlled sources to critical code regions, which is impossible with a function, local slice or file-level graph, and therefore captures the impact of a given patch on the system's security posture.

Embodiments further include a new explainable Graph Neural Network (GNN) to receive the above graph representation of a given patch and automatically infer vulnerable or flawed paths within the patch. The GNN may use Graph Isomorphism Network (GIN) layers to train an inductive model to infer detection rules applied to the graphs. This model may be especially suited for processing long input graphs due to its skip-connections and attention mechanism. The trained attention weights of the attention mechanism can be interpreted as relevance scores per node to achieve a fine-granular localization of vulnerabilities. A new technique for generating labeled training data for the above model is also described, which does not require a dataset of patches with known vulnerabilities.

The aforementioned optional value-set analysis inserts variable domains within the graphs to assist model reasoning regarding potential bounds and sanitizations. For example, whether or not the value of a user-controlled variable or a buffer length is bounded may beneficially affect the model's training and inferences.

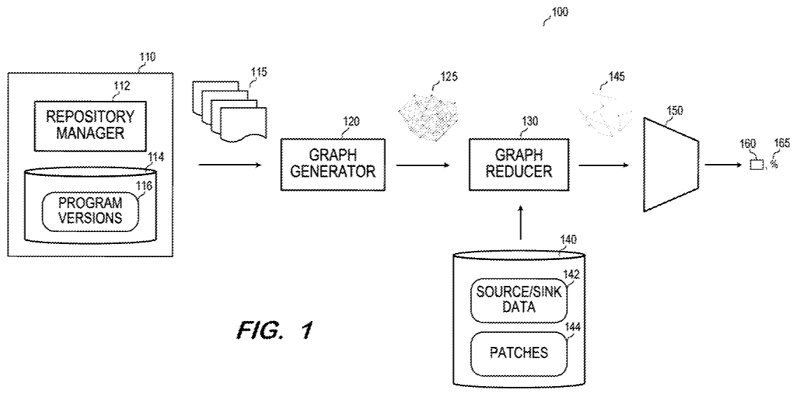

FIG. 1 illustrates system 100 according to some embodiments. Each of the illustrated components of system 100 may be implemented using any suitable combinations of computing hardware and/or software that are or become known. In some embodiments, two or more components of system 100 are implemented by a single computing device.

The components of system 100 may be on-premise, cloud-based (e.g., in which computing resources are virtualized and allocated elastically), distributed (e.g., with distributed storage and/or compute nodes) and/or deployed in any other suitable manner. Each component may comprise disparate cloud-based services, a single computer server, a cluster of servers, and any other combination that is or becomes known. All or a part of each system may utilize Infrastructure-as-a-Service (IaaS), Platform-as-a-Service (PaaS) and/or Software-as-a-Service (SaaS) offerings owned and managed by one or more different entities as is known in the art.

Code repository 110 may comprise any system suitable for storing code of software programs. Code repository 110 includes repository manager 112 which may provide, collaboration, code review, pull requests, branching, project management, etc. Repository manager 112 also provides versioning allow software developers to track patches to software programs, which include changes that may implement bug fixes or feature enhancements and which may span multiple files and functions of a software program. Generally, a patch [P [symbol] P] is a transition from one program P′ to another program P.

Versions of programs 116 are stored in storage 114 of repository 110. Each version of a given program may be associated with a patch which includes the differences between the version of the program and a previous version of the program. Storage 114 may also store the files of each patch in association with a unique identifier, which is in turn associated with the program and version which incorporates the patch.

According to some embodiments, graph generator 120 receives code files 115 of a software program from repository 110. Code files 115 may conform to any programming language that is or becomes known, including but not limited to JavaScript, C++, and ABAP. The software program represented by code files 115 may comprise an application, a microservice, a library, etc.

Graph generator 120 generates interprocedural data flow graph 125 based on code files 115. As will be described in detail below, interprocedural data flow graph 125 may comprise nodes, edges and attributes thereof. Interprocedural data flow graph 125 may represent the syntactic structure, statement execution order, variable assignments and references, variable read and write access, function call context, and the flow of user-controlled variables of the program represented by code files 115. According to some embodiments, graph generator 120 also attaches lower-bound and upper-bound domains to every reference node v∈V_{D} of graph 125 as will be described below.

Graph reducer 130 generates reduced graph 145 from graph 125. Graph 145 consists of paths through graph 125 which originate at a source node, terminate at a sink node, and include at least one edit node. Graph reducer 130 combines the paths at their common nodes, if any, to generate reduced graph 145.

A source node is typically related to code which receives user input and a sink node is related to critical code regions such as I/O functions. Critical code regions may also include code in which data is (intentionally or accidentally) used as instructions for the computer, such as in dynamically-composed queries (i.e., raising the danger of SQL injection) or when the data is written to memory out of the foreseen bounds (i.e., causing buffer overflows leading to the danger of this data being interpreted as instructions and subsequently executed.

Edit nodes represent code which is modified by the subject patch. Graph reducer 130 may identify the source nodes and sink nodes of graph 125 based on source/sink data 142 of storage 140. Source/sink data 142 provides examples of code statements and/or functions in the language of the subject program which correspond to sources and sinks. Patches 144 includes files of one or more patches, including the subject patch. These files may be used to identify the nodes of graph 125 which represent code that is modified by the subject path. As described above, the files of the patch may also or alternatively be stored in repository 110 in association with the subject program.

Reduced graph 145 is input to trained classification model 150 to generate classification 160 and corresponding likelihood 165. As will be described in detail below, trained classification model may comprise a GNN using GIN layers including skip-connections between the layers. Other types of GNNs or even graph transformer networks can be used. In some examples, classification 160 and likelihood 165 may indicate an 82% certainty that the subject patch includes a vulnerability, or a 92% certainty that the subject patch is clean (i.e., does not include a vulnerability).

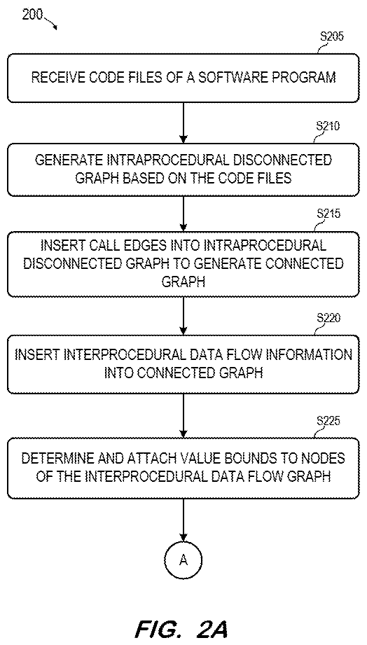

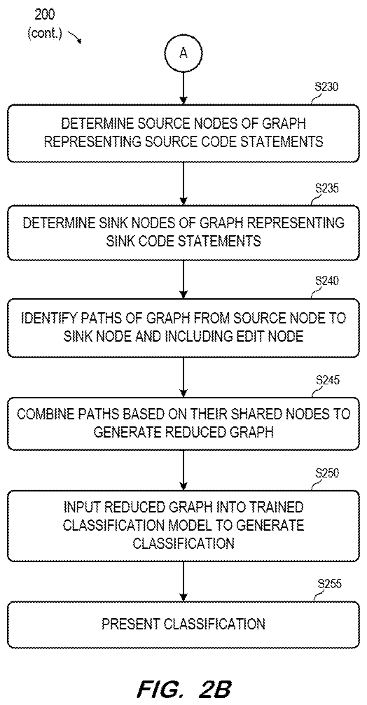

FIGS. 2A and 2B comprise a flow diagram of process 200 to determine vulnerability of a software patch according to some embodiments. Process 200 and the other processes described herein may be performed using any suitable combination of hardware and software. Software program code embodying these processes may be stored by any non-transitory tangible medium, including a fixed disk, a volatile or non-volatile random access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture. Embodiments are not limited to the examples described below.

Initially, code files of a software program are received at S205. The code files comprise a version of a software program P′ resulting from the application of a patch to another version of the software program P. The patch specifies the changes made to the code files of software program P which resulted in the code files of software program P′. The code files may be received at S205 as part of a CI/CD process prior to committing the patched program or otherwise moving the patched program into production.

An intraprocedural disconnected graph is generated based on the code files at S210. Generally, a code graph G=G(V, E) with vertices V and edges E⊆V×V. Elements of V or E are also assigned values in a feature space. An abstract syntax tree (AST) of a function is the result of parsing its source such that the leaf nodes in the resulting tree G_{A}=G(V_{A}, E_{A}) are the literals and the edges E_{A} describe the composition of syntactic elements.

The semantic attributes of a function can be captured in flow graphs depicting the flow of control or the flow of information. A control flow graph (CFG) of a program is G_{C}=G(V_{C}, E_{C}) with the nodes V_{C}⊂V_{A} being statements, and where directed edges E_{C} describe the execution order of the statements V_{C}⊂V_{A}. A data flow graph (DFG) of a program is G_{D}=G(V_{D}, E_{D}) with the nodes V_{C}⊂V_{A} being variable assignments and references, and where directed edges E_{D} describe read or write access from or to a variable.

A code composite graph (CCG) is a graph G_{CCG} created for each function {f₁, f₂, . . . , fₙ} of the program at S210. G_{CCG} combines the syntactic elements of the AST with the semantic information of the CFG and DFG such that V=∪ᵢ₌₁ⁿ V_{A}ⁱ and E=E_{A}∪E_{D}∪E_{C}. The set of all created graphs G_{CCG} comprises an intraprocedural disconnected graph.

Call edges are inserted into the intraprocedural disconnected graph to generate a connected graph at S215. The call graph (CG) of a program is defined as G_{CG}=G(V_{CG}, E_{CG}) where the nodes V_{CG}⊂V_{A} are function call-sites and definitions, and the edges E_{CG} connect the call-sites with a respective function definition. Each CCG generated at S210 is connected by adding CG edges E_{CG}, resulting in a single connected graph for P with V=∪ᵢⁿ V_{A}ⁱ and E=E_{A}∪E_{D}∪E_{C}∪E_{CG}.

Interprocedural data flow information is inserted into the connected graph at S220. The connected graph provides information regarding the relationship between program functions during execution. Interprocedural data flow information added at S220 is intended to enhance representation of user-controlled variables.

A function call vᵢ→v₂ is considered, with (v₁, v₂)∈E_{CG}. Since v₁ is a call statement its accompanying argument nodes can be associated, as can the function parameters represented in the function signature of the callee v₂. The argument nodes are sorted by their appearance in the function definition and connected pairwise to create edges E_{IDFG}. During static analysis, it is difficult to infer whether a variable passed by reference may be written to or only read from, thus, edges E_{IDFG} between pointers are modelled as a bidirectional relationship. The resulting interprocedural data flow graph (IDFG) is defined as G_{IDFG}, where V_{IDFG}⊆∪ᵢ₌₁ⁿ V_{D}ⁱ with E_{IDFG} connecting parameters in a function call to their respective arguments in a function definition.

Next, at S225, value bounds are determined and attached to corresponding nodes of the interprocedural data flow graph. Given G_{D} any variable assignment vₑ∈V_{D} can be selected to find (vₛ, vₑ)∈E_{D} where vₑ reads from vₛ. If vₛ is a constant and vₑ is a Boolean, Float or Integer operation, vₑ can be evaluated. If vₛ is not a constant, (v, vₛ)∈E_{D} is found and the process repeats. If vₑ can be evaluated, the evaluated value is attached to the node. Otherwise, if the operation cannot be evaluated because, for instance, one data flow dependent v_{d} of vₑ relies on I/O input or external API calls, vₑ is annotated with v_{d}.

All expressions within surrounding conditional blocks that may act as invariants are then located. If a variable within a conditional block appears in a conditional of the form <var> <comparison> <expression>, its bounds are annotated with its value if the value could be evaluated in the previous step. Lower-bound and upper-bound domains may also be attached to every reference node v∈V_{D}.

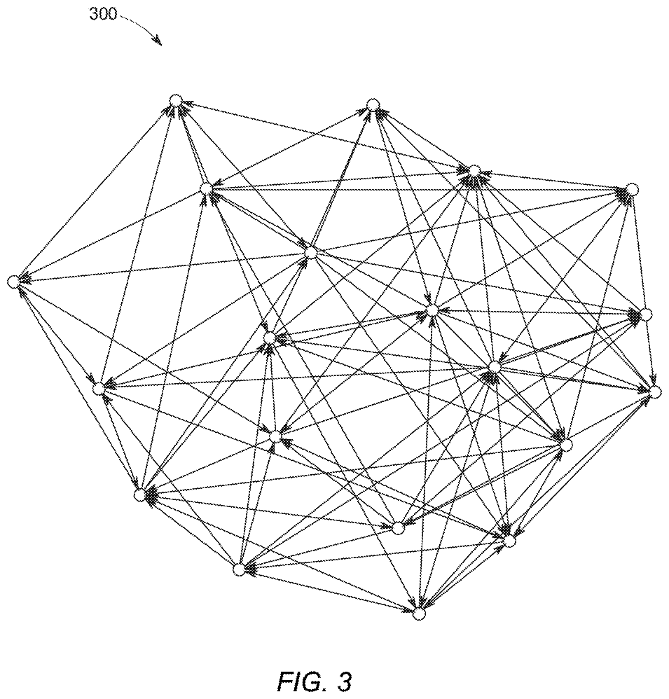

FIG. 3 illustrates interprocedural data flow graph 300 according to some embodiments. As noted above, graph 300 may include multiple directed and non-directed edges connecting a given two nodes. As also mentioned, graph 300 includes a plurality of source nodes, a plurality of sink nodes and a plurality of edit nodes.

The source nodes and the sink nodes are determined at S230 and S235, respectively. The source nodes of graph represent source functions within the subject program while the sink nodes represent sink functions. The definitions of source nodes and sink nodes may be specific to the intended use and can be set accordingly. Examples of source functions identifying source nodes may include the following in some embodiments:

| Function | Description |
|---|---|
| getchar/getc/getch | Reads a char from stdin |
| fgets | Reads a line from a stream |
| read | Reads from a file descriptor |
| fopen | Opens a file |
| scanf | Reads formatted input from stdin |
| gets | Reads input from stdin |
| fscanf | Reads formatted input from a stream |
| getenv/secure_getenv | Reads from an environment variable |
| fread | Reads input from a stream |
| poll/ppoll | Wait for event on file descriptor |
| recvfrom/recv/recvmsg | Receives message from socket |

while examples of sink functions identifying sink nodes may include the following in some embodiments:

| Function | Description |
|---|---|
| malloc/calloc/realloc | Allocate heap memory. |
| memcpy | Copies memory content. |
| strcpy | Copies string content. |
| printf/snprintf/sprintf | Provides formatted output. |
| memset | Initializes memory. |
| strcat | Concatenates strings. |
| free | Deallocates memory. |

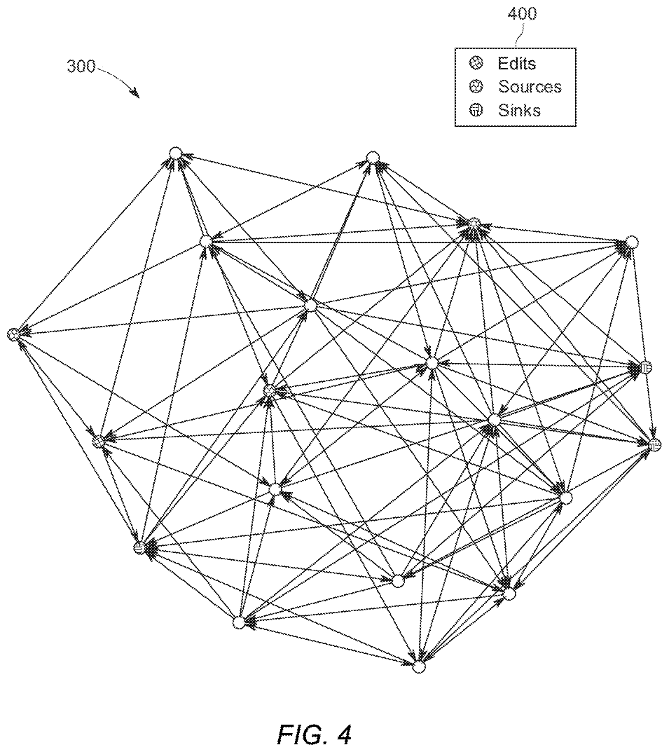

FIG. 4 depicts determined source, sink, and edit nodes of graph 300 according to some embodiments. Legend 400 indicates visual characteristics of each of these node types within graph 300. As mentioned above, the edit nodes may be identified by determining the code regions changed by the current patch under analysis and identifying the nodes of graph 300 which represent those code regions.

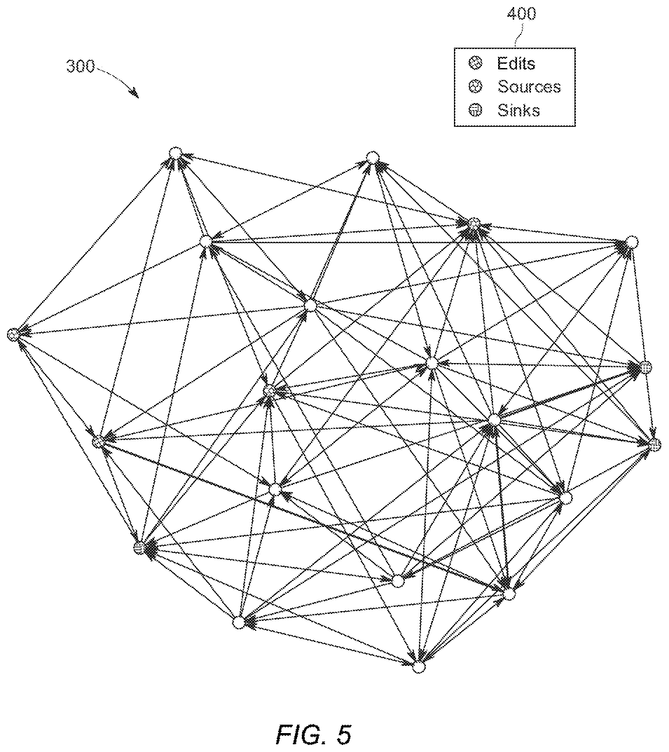

At S240, paths of the graph are identified which begin at a source node, end at a sink node and include at least one edit node. Formally, a single path p of a patch [P′ [symbol] P] is an oriented path with vertices v₀, . . . , v_{b}, . . . vₑ starting at v₀∈V_{sourc} e, passing through v_{b}∈V_{edit} and ending in vₑ∈Vₛᵢₙₖ where all the edges are in E_{IDFF}G, E_{DFG} or E_{CFG}. To identify the paths at S240, forward slicing may be performed from each V_{edit} to zero or more Vₛᵢₙₖ following any IDFG, DFG or CFG edges while neglecting the AST and CG edges. FIG. 5 illustrates a forward-sliced path from the V_{edit} of graph 300 to a Vₛᵢₙₖ of graph 300. Forward slicing generates a set of paths that describe the code changed by a patch and potentially flowing into critical sinks.

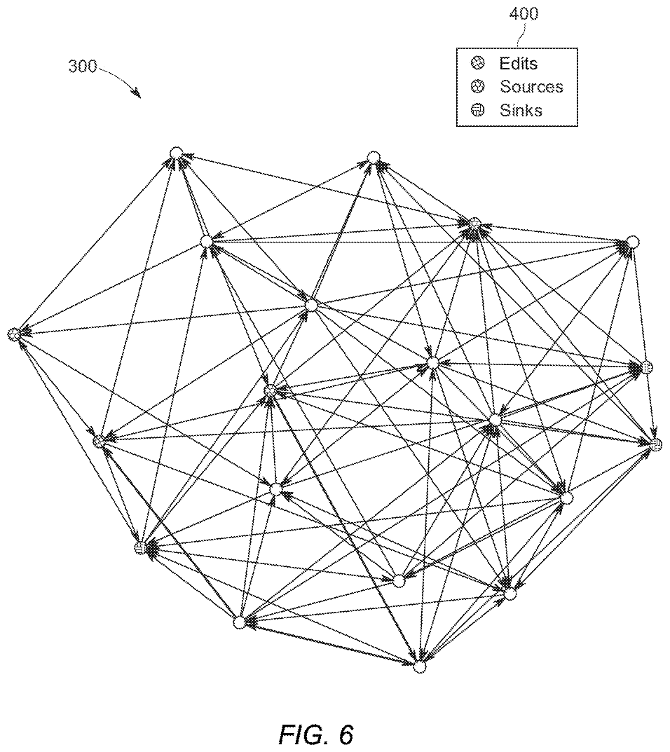

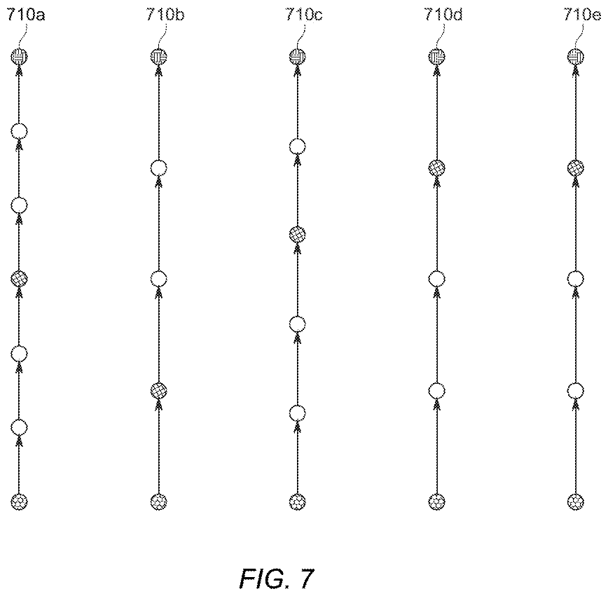

Backward slicing from each V_{edit} to zero or more V_{source} is also performed at S240, as illustrated by the traced path of FIG. 6. The paths identified via forward and backward slicing are then combined based on common edit nodes, resulting in a set of paths describing all flows starting with user-defined inputs intersecting the patched code regions and reaching the critical sinks. FIG. 7 illustrates such combined paths 710a through 710e according to some embodiments.

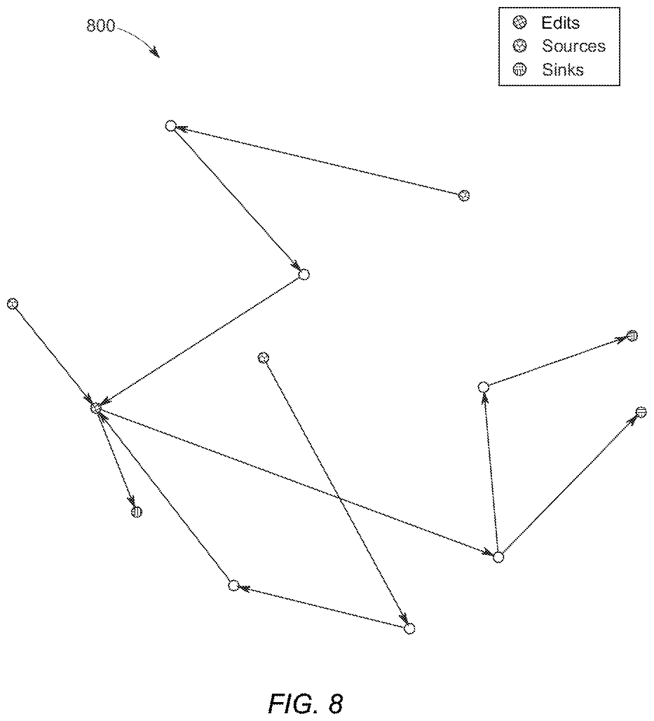

Next, at S245, all identified taint paths are combined at their patch intersections V_{edit} to generate a reduced graph. A reduced graph of a patch [P′ [symbol] P] is defined as G_{RG} joining its paths {p¹, p², . . . , p^{k}} at their common AST nodes. FIG. 8 illustrates reduced graph 800 including paths 710a through 710e according to some embodiments. Since the number of paths in G_{RG} might become exponentially large in some cases, each G_{RG} may be further reduced by sub-sampling k paths thereof to achieve reasonable performance.

The reduced graph is input to a trained classification model at S250 to generate a classification. The trained classification model may comprise a GNN using GIN layers which rely on the following update and aggregation mechanism:

$${h}^{( l )} = {W}^{( l - 1 )} ( ( A + ( 1 + ϵ ) \times I ) \times relu ( {h}^{( l - 1 )} ) )$$

Since the reduced graphs described herein are potentially longer and exhibit a smaller average degree than traditional code graphs, embodiments may implement several features to assist retention of important information over large distances. First, E in the update and aggregation mechanism is set as a trainable parameter, which is particularly useful in conjunction with GIN to reduce the smoothing out of information from distant nodes. Furthermore, skip-connections are used between the layers to assist the propagation of relevant information across the topology.

According to some embodiments, the model includes three single graph encoding layers followed by two multi-layer perceptrons (MLPs) to calculate a relevance score for nodes and edges. The output space of the MLP is halved to perform a latent space disentanglement, where the first half will later be optimized to contain only the important nodes which are causal (e.g., denoted by superscript c) for the task and the second half will be trained to only contain the trivial part (e.g., denoted by superscript t) of the graph which can be considered noise.

Accordingly, for any node vᵢ∈V, the node attention is calculated as:

aᵢ^{c},aᵢ^{t}=σ(MLP_{Node}(hᵢ))

and for any pair of nodes (vᵢ, vⱼ)∈E their edge attention is calculated as:

bᵢⱼ^{c},bᵢⱼ^{t}=σ(MLP_{Edge}(hᵢ∥hⱼ))

A mean readout layer is then applied as a pooling strategy followed by a final MLP with softmax activation as the prediction head, returning a classification of either Vulnerable or Clean. Using the attention scores, the attention masks Mₓ, \hat{M}ₓ, Mₐ, \hat{M}ₐ can be respectively calculated for the causal and trivial features, and for the causal and trivial edges. Application of these masks to the adjacency matrix and feature matrix of the reduced graph yields [symbol] and [symbol] for the causal and trivial subgraphs respectively. The causal graph can be used to explain the predicted classification and determine the cause of a Vulnerable classification.

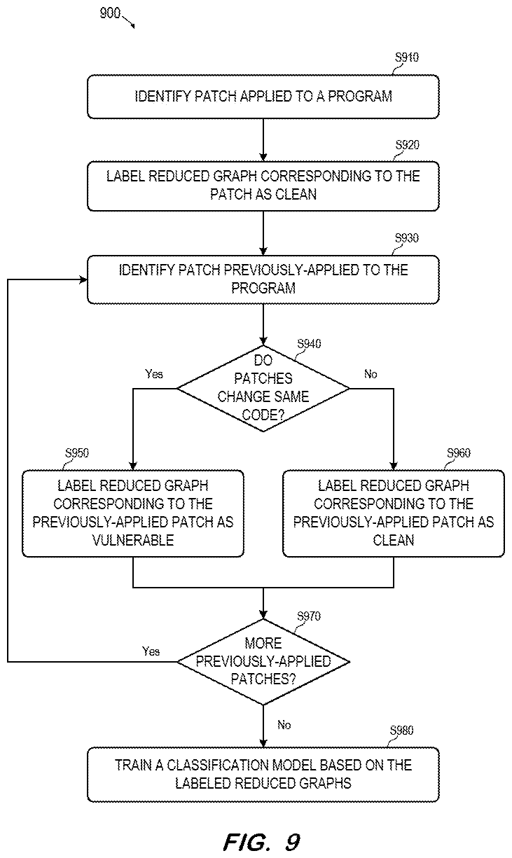

FIG. 9 is a flow diagram of process 900 to train a classification model to output a label based on a reduced graph of a plurality of edit paths according to some embodiments. In order to train an ML model to determine whether a patch potentially introduces a vulnerability, it would be most helpful to have a dataset of committed patches which are known to add vulnerabilities to a program. However, such a dataset rarely exists and is not trivial to create, since, for example, a vulnerability caused by a patch might not manifest itself within a program until several subsequent patches are committed. Instead, currently-available datasets typically contain committed patches which are known to fix, rather than introduce, vulnerabilities.

To generate labeled training data for the present purposes based on such a dataset, process 900 begins at S910 by identifying a patch applied to a program. For example, a code repository may store different versions of a program, where each version is associated with a patch that was applied to a prior version of the program. S910 may therefore consist of identifying a patch and a version of a program to which the patch is applied. It will be assumed that this patch does not introduce vulnerabilities, i.e., the patch is clean. Accordingly, at S920, a reduced graph of the program is created based on the code regions edited by the patch as described above, and the reduced graph is assigned a label of Clean.

According to some embodiments, process 900 only considers patches associated with reduced graphs having a pre-defined maximum length. For example, it might be assumed that most C and C++ open-source projects exhibit a maximum call-stack depth of 15, and the pre-defined maximum length may correspond to that maximum call-stack depth.

At S930, a patch which was previously applied to the program is identified. In a simple example, the patch identified at S910 was applied to version 2.0 of a program to result in version 3.0 of the program. The patch identified at S930 may in this case be a patch which was applied to version 1.0 of the program to result in version 2.0 of the program.

At S940, it is determined whether the patches identified at S910 and S930 change the same code of the program. The determination at S940 may comprise determining the code files and the lines of the code files changed by each patch and determining whether the patches changed any of the same lines. Some embodiments may refine the determination at S940 by determining, for example, whether the number of common changed lines is greater than a certain threshold number and/or whether the percentage of common changed lines to all changed lines is greater than a threshold.

If it is determined that the patches change the same code of the program, a reduced graph is determined at S950 based on the code regions edited by the previously-applied patch identified at S930 and the version of the program resulting from this patch. This reduced graph is assigned a label of Vulnerable, under the assumption that the patch identified at S910 fixed a vulnerability introduced by the previously-applied patch.

If it is determined at S940 that the identified patches do not change any of the same code lines of the program, a reduced graph is determined at S960 based on the code regions edited by the previously-applied patch identified at S930 and the version of the program resulting from this patch. This reduced graph is assigned a label of Clean.

At S970, it is determined whether more patches that were previously applied to the program exist. If so, flow returns to S930 to identify another previously-applied patch. Continuing the above example, the patch identified at this instance of S930 may be a patch which was applied to version 0.5 of the program to result in version 1.0 of the program. Flow then continues as described above to evaluate the newly-identified patch against the patch identified at S910 and to create a labeled reduced graph based thereon.

Once it is determined at S970 that no more previously-applied patches exist, flow proceeds to S980 to train a classification model based on the labeled reduced graphs. Additional labeled reduced graphs may be determined by identifying a patch applied to another program at S910 and performing S920-S970 with respect to previously-applied patches of the other program, for example.

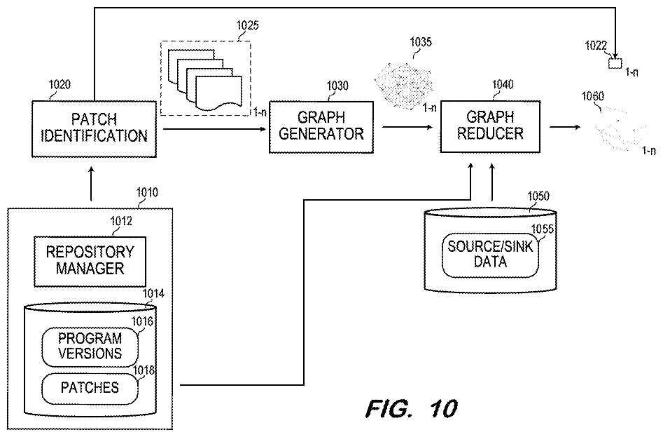

FIG. 10 is a diagram of a system to generate labeled reduced graphs according to some embodiments. The components of FIG. 10 may operate to execute process 900 in some embodiments.

Repository 1010 includes repository manager 1012 and storage 1014. Repository manager 1012 may store and retrieve program versions 1016 (i.e., program code and patched program code) and patches 1018 to and from storage 1014 as is known in the art.

Patch identification component 1020 may identify a first patch of patches 1018 and determine whether each of N other patches of patches 1018 change the same code as the first patch. Component 1020 assigns a label 1022 to each of the N patches based on the determinations, indicating whether a corresponding patch is Clean or Vulnerable.

Patch identification component 1020 also transmits N sets of code files 1025 to graph generator 1030, where each set of code files 1025 corresponds to one program version and to one of the N patches. Graph generator 1030 generates a graph 1035 corresponding to each of the N program versions as described above. Next, graph reducer 1040 operates as described above to generate a reduced graph 1060 for each of the N program versions based on source/sink data 1055 of storage 1050 and patches 1018 corresponding to each program version. Each reduced graph 1060 is then assigned a label 1022 associated with its corresponding graph.

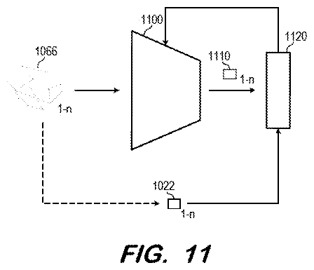

FIG. 11 illustrates the training of causal GIN (CGIN) model 1100 at S980 based on labeled reduced graphs according to some embodiments. Each training data instance includes a reduced graph 1066 and its corresponding label 1022 as described above with respect to FIGS. 9 and 10.

During training, a batch of reduced graphs 1066 are input to model 1100, which outputs a classification 1110 for each graph 1066. Prior to input, textual code that is attached to every AST node of a graph 1066 may be converted to a vector using Word2Vec or other token embeddings (e.g., transformer-based embeddings). Loss layer 1120 compares the classification output for each reduced graph 1066 of the batch with a label 1022 corresponding to the reduced graph 1066 to determine a total loss. The loss is back-propagated to model 1100 which is modified based thereon. Training continues in this manner until satisfaction of a given performance target or a timeout situation.

Training of model 1100 may include a traditional negative log likelihood (NLL)-loss [symbol] in view of the ground truths [symbol] and the latent representation of the causal graph h_{G}_{_{c}} as depicted in:

$${ℒ}_{sup} = - \frac{1}{\vert 𝒟 \vert} {\sum }_{𝒢 ∈ 𝒟} {y}_{𝒢}^{T} log ( σ ( {h}_{{𝒢}^{c}} ) )$$

A representation of the trivial subgraph [symbol] may then be used to optimize the model to separate trivial and causal features by fitting the model with the trivial subgraph [symbol] to be close to a uniform distribution using the Kullback-Leibler divergence (KL):

$${ℒ}_{unif} = \frac{1}{\vert 𝒟 \vert} {\sum }_{𝒢 ∈ 𝒟} K L ( {y}_{unif} , σ ( {h}_{{𝒢}^{t}} ) )$$

It is noted that just as an image classifier trained to classify boats may pay spurious attention to the feature water, vulnerability discovery models may, for example, pay spurious attention to artifacts such as the coding style of authors which produced vulnerabilities in the past. To reduce the effect of such bias, a backdoor adjustment may be applied to reduce the influence of any confounding variable. This adjustment can be achieved by conditioning the causal graph per sample with all possible trivial graphs [symbol] ^{t} with t∈ [symbol] obtained during training. This conditioning stabilizes training and helps reduce the influence of noise and spurious correlated features in the reduced graph as defined below:

$${ℒ}_{caus} = - \frac{1}{\vert 𝒟 \vert \cdot \vert 𝒯 \vert} {\sum }_{𝒢 ∈ 𝒟} {\sum }_{t ∈ 𝒯} {y}_{𝒢}^{T} log ( σ ( {h}_{{𝒢}^{c}} + {h}_{{𝒢}^{t}} ) )$$

By optimizing the model during training to minimize [symbol] ₛᵤₚ+ [symbol] _{unif}+ [symbol] _{caus}, a neural network may be produced that is able to process potentially-long reduced graphs and provide noise-resistant localization of vulnerabilities.

Embodiments of the concepts described above may be realized and applied in different settings and combinations. For example, the amount of semantic information contained in a CCG can be reduced, e.g., by omitting control flow edges. A CCG can also be enhanced by adding edges from additional semantic sub-graphs connecting AST nodes. The value-set analysis may be omitted or replaced by another technique which considers program variables such as, e.g., symbolic execution.

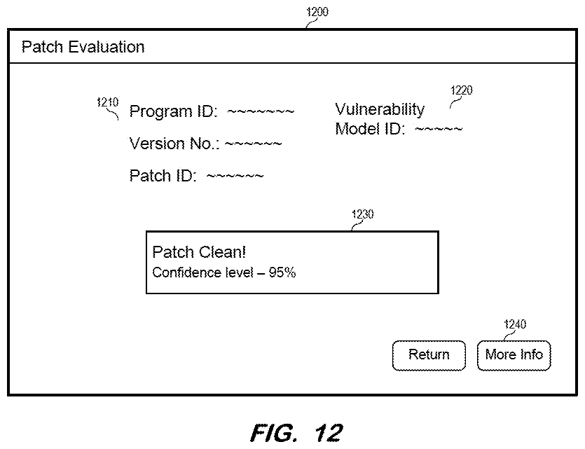

FIG. 12 illustrates user interface 1200 to present a classification of a software patch according to some embodiments. In one example, an administrator operates a Web browser to access a CI/CD application via a corresponding Uniform Resource Locator (URL) and the application returns an interface such as interface 1200. According to some embodiments, interface 1200 is presented by a device executing a client application (e.g., a Web application) which communicates with an application provided by a cloud-based system.

Interface 1200 includes fields 1210 identifying a program, a version of the program, and a patch corresponding to the version. It is assumed that the application has been previously operated to evaluate the patch using a model trained as described above. The particular trained model is identified by field 1220. As also described above, such evaluation includes generating a reduced graph based on the patch and the program version, and inputting the reduced graph to the trained model.

Field 1230 provides inference results output by the model. The results include a predicted label (i.e., Clean) and a model confidence level (i.e., 95%). More info control 1240 may be selected to request additional information to explain the classification. In a case that the classification was Vulnerable, the additional information may identify nodes of the reduced graph (and associated code regions) which particularly influenced the inference.

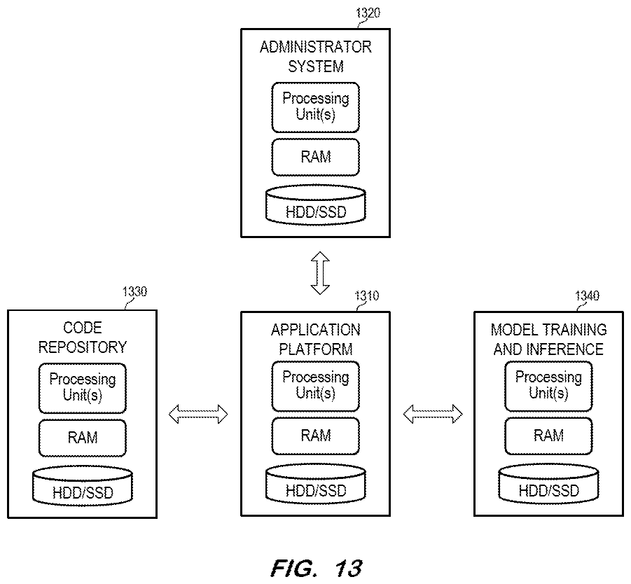

FIG. 13 is a diagram of a cloud-based implementation according to some embodiments. Administrator system 1320 may comprise a local computing system operated by an administrator to manage software upgrades via an application executing on application platform 1310. The application may retrieve program files and a corresponding patch from code repository 1330 and generate a reduced graph as described above. The reduced graph, in turn, may be provided to model training and inference system 1340 to generate a vulnerability label based on the reduced graph and a trained model. The label is then returned to the administrator via the application.

Each of systems 1310, 1330 and 1340 may comprise cloud-based resources residing in one or more public clouds providing self-service and immediate provisioning, autoscaling, security, compliance, and identity management features. Systems 1310, 1330 and 1340 may comprise servers or virtual machines of respective Kubernetes clusters, but embodiments are not limited thereto.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable recording media. Such media may include, for example, a hard disk, a DVD-ROM, a Flash drive, magnetic tape, and solid-state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a memory storing processor-executable program code; and
at least one processing unit to execute the processor-executable program code to cause the system to:
receive code files of a software program including code regions changed by applying a software patch to the program;
generate an interprocedural data flow graph based on the code files;
identify first nodes of the interprocedural data flow graph representing the code regions changed by applying the software patch to the program;
identify a plurality of paths of the interprocedural data flow graph, each of the identified plurality of paths originating at a source node of the graph, including at least one of the identified first nodes, and terminating at a sink node of the graph, where each of the identified first nodes is included in at least one of the identified plurality of paths;
combine the identified plurality of paths based on ones of the first nodes included in two or more of the plurality of paths;
input the combined plurality of paths to a trained classification model to generate a classification; and
present the classification.

2. The system according to claim 1, wherein generation of an interprocedural data flow graph based on the code files comprises:
generation of an intraprocedural disconnected graph based on the code files;
insertion of call edges into the intraprocedural disconnected graph to generate a connected graph; and
insertion of interprocedural data flow information into the connected graph.

3. The system according to claim 2, the at least one processing unit to execute the processor-executable program code to cause the system to:
determine and attach value bounds to a plurality of nodes of the interprocedural data flow graph.

4. The system according to claim 1, wherein each of the source nodes represents source function code of the program, and wherein each of the sink nodes represents sink function code of the program.

5. The system according to claim 1, wherein identification of the plurality of paths of the graph comprises:
determination of a plurality of forward edit paths of the graph, each of which begins at one of the first nodes and terminates at a sink node;
determination of a plurality of backward edit paths of the graph, each of which begins at one of the first nodes and terminates at a source node; and
combination of the plurality of forward edit paths and the plurality of backward edit paths based on their common first nodes.

6. The system according to claim 1, wherein the classification model is trained based on labeled reduced graphs.

7. The system according to claim 6, wherein the labeled reduced graphs comprise:
a first labeled reduced graph generated based on a first version of the software program associated with a first patch, and labeled as Clean; and
a second labeled reduced graph generated based on a second version of the software program associated with a second patch applied to the program prior to the first patch, wherein the second patch and the first patch change at least one common code region, the second labeled reduced graph labeled as Vulnerable.

8. The system according to claim 7, wherein the labeled reduced graphs comprise:
a third labeled reduced graph generated based on a third version of the software program associated with a third patch applied to the program prior to the first patch, wherein the third patch and the first patch do not change at least one common code region, the third labeled reduced graph labeled as Clean.

9. A method comprising:
receiving code files of a program, the program including code regions changed by applying a patch to the program;
generating an interprocedural data flow graph from the code files;
identifying first nodes of the interprocedural data flow graph representing the code regions changed by applying the patch to the program;
identifying a plurality of source nodes of the graph;
identifying a plurality of sink nodes of the graph;
identifying a plurality of paths of the interprocedural data flow graph, each of the identified plurality of paths originating at one of the plurality of source nodes of the graph, including at least one of the identified first nodes, and terminating at one of the plurality of sink nodes of the graph, where each of the identified first nodes is included in at least one of the identified plurality of paths;
combining the identified plurality of paths based on their common first nodes to generate a reduced graph; and
inputting the reduced graph to a trained classification model to generate a classification.

10. The method according to claim 9, wherein generating an interprocedural data flow graph from the code files comprises:
generating an intraprocedural disconnected graph based on the code files;
inserting call edges into the intraprocedural disconnected graph to generate a connected graph; and
inserting interprocedural data flow information into the connected graph.

11. The method according to claim 10, further comprising:
determining and attaching value bounds to a plurality of nodes of the interprocedural data flow graph.

12. The method according to claim 9, wherein each of the identified source nodes represents source function code of the program, and wherein each of the identified sink nodes represents sink function code of the program.

13. The method according to claim 9, wherein identifying the plurality of paths of the graph comprises:
determining a plurality of forward edit paths of the graph, each of which begins at one of the first nodes and terminates at a sink node;
determining a plurality of backward edit paths of the graph, each of which begins at one of the first nodes and terminates at a source node; and
combining the plurality of forward edit paths and the plurality of backward edit paths based on their common first nodes.

14. The method according to claim 9, wherein the classification model is trained based on labeled reduced graphs.

15. The method according to claim 14, wherein the labeled reduced graphs comprise:
a first labeled reduced graph generated based on a first version of the program associated with a first patch, and labeled as Clean; and
a second labeled reduced graph generated based on a second version of the program associated with a second patch applied to the program prior to the first patch, wherein the second patch and the first patch change at least one common code region, the second labeled reduced graph labeled as Vulnerable.

16. The method according to claim 15, wherein the labeled reduced graphs comprise:
a third labeled reduced graph generated based on a third version of the software program associated with a third patch applied to the program prior to the first patch, wherein the third patch and the first patch do not change at least one common code region, the third labeled reduced graph labeled as Clean.

17. A non-transitory computer-readable recording medium storing processor-executable code, the code executable by a computing system to:
receive code files of a program, the program including code regions changed by applying a patch to the program;
generate an interprocedural data flow graph from the code files;
identify first nodes of the interprocedural data flow graph representing the code regions changed by applying the patch to the program;
identify a plurality of source nodes of the graph;
identify a plurality of sink nodes of the graph;
identify a plurality of paths of the interprocedural data flow graph, each of the identified plurality of paths originating at one of the plurality of source nodes of the graph, including at least one of the identified first nodes, and terminating at one of the plurality of sink nodes of the graph, where each of the identified first nodes is included in at least one of the identified plurality of paths;
combine the identified plurality of paths based on their common first nodes to generate a reduced graph; and
input the reduced graph to a trained classification model to generate a classification.

18. The medium according to claim 17, wherein generation of an interprocedural data flow graph from the code files comprises:
generation of an intraprocedural disconnected graph based on the code files;
insertion of call edges into the intraprocedural disconnected graph to generate a connected graph; and
insertion of interprocedural data flow information into the connected graph.

19. The medium according to claim 18, wherein generation of an interprocedural data flow graph from the code files comprises:
determination and attachment of value bounds to a plurality of nodes of the interprocedural data flow graph.

20. The medium according to claim 17, wherein the classification model is trained based on labeled reduced graphs comprising:
a first labeled reduced graph generated based on a first version of the program associated with a first patch, and labeled as Clean;
a second labeled reduced graph generated based on a second version of the program associated with a second patch applied to the program prior to the first patch, wherein the second patch and the first patch change at least one common code region, the second labeled reduced graph labeled as Vulnerable; and
a third labeled reduced graph generated based on a third version of the software program associated with a third patch applied to the program prior to the first patch, wherein the third patch and the first patch do not change at least one common code region, the third labeled reduced graph labeled as Clean.
